(19) United States
(12) Patent Application Publication
(10) Pub. No.: US 2010/0241855 A1
(43) Pub. Date: Sep. 23, 2010

(54) Systems and Methods for Secure Execution of Code Using a Hardware Protection Module

(75) Inventors: Hung-Te Chou, Shindian City (TW); Kuang-che Wu, Zhonghe City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Cyberlink Corp., Shindian City (TW)

(21) Appl. No.: 12/405,518

(22) Filed: Mar. 17, 2009

(51) Int. Cl. H04L 9/32; H04L 9/00

(52) U.S. Cl. 713/168; 713/150

(57) ABSTRACT

Systems and methods for securely executing digital rights management software comprising content code are described. One method comprises receiving encrypted multimedia content and content code from a storage medium by a host processor, wherein the content code provides restricted content distribution by examining an environment in which a player application resides. Based on functions defined within the content code, the host processor partitions the content code into portions. Based on whether the functions corresponding to the portions are related to computations involving confidential data, commands and parameters related to the portions of the content code are generated and forwarded to a secure processor for decrypting the encrypted multimedia content.

### TECHNICAL FIELD

The present disclosure generally relates to multimedia content and more particularly, relates to providing a secure environment for executing code. Specifically, a secure environment is implemented by incorporating a hardware protection module.

### BACKGROUND

With the increasing amount of audio and video content available to consumers through broadcast, cable, on-demand, fixed media, and other available sources of multimedia content, consumers have easy access to an increasing amount of content and programming. Furthermore, many devices (e.g., personal computers, DVD recorders) and services that are readily available allow consumers to record, time-shift or view on-demand video and audio content. Generally, video content can be stored in any number of common formats such as MPEG-1, MPEG-2, or DV (digital video), for example. Likewise, audio content may be stored in any number of common digital formats such as MP3, WAV, or MPEG Audio, for example. The availability of multimedia content in a vast array of digital formats has helped make distribution of multimedia content easier because of the high degree of portability. Video playback systems are well known, and there are a variety of current standards that govern the format and other attributes associated with the various video playback systems.

Blu-ray Disc (BD) offers advantages over DVDs and other previous optical standards in various ways, including increased storage capacity and enhanced interactivity (disc content authoring, seamless menu navigation, network/Internet connectivity, etc.). The Blu-ray Disc framework offers content providers almost unlimited functionality when creating interactive titles. As such, Blu-ray Disc provides greater levels of user control and interactivity involving the underlying video content. Unfortunately, piracy of audio/visual works continues to proliferate as hackers facilitate the unauthorized distribution of multimedia content. Because of the capability in accessing and copying multimedia content stored on DVDs, for example, video and audio piracy continues to be an ongoing problem. Such piracy continues to be a problem even in light of the copy-restricted mechanisms that DVDs generally employ.

### SUMMARY

At least one embodiment is a method that comprises receiving encrypted multimedia content and content code from a storage medium by a host processor, wherein the content code provides restricted content distribution by examining an environment in which a player application resides. Based on functions defined within the content code, the host processor partitions the content code into portions. Based on whether the functions corresponding to the portions are related to computations involving confidential data, commands and parameters related to the portions of the content code are generated and forwarded to a secure processor for decrypting the encrypted multimedia content.

Another embodiment is a playback system for executing digital rights management software and outputting multimedia content. The playback system comprises a media interface for receiving the encrypted multimedia content and content code from a storage medium, a host processor configured to execute logic for partitioning the content code into portions based on functions to be performed by the content code. The playback system further comprises a secure hardware protection module communicatively coupled to the host processor, wherein the secure hardware protection module comprises a secure processor configured to receive and execute commands associated with the portions of the content code related to computations involving confidential data, wherein the secure processor is accessible only by the host processor and an output interface configured to output decoded multimedia content to an output device.

Another embodiment is a computer-readable medium storing a program for execution on a host processor. The program comprises computer executable instructions configured to perform the steps of receiving encrypted multimedia content and content code from a Blu-ray Disc (BD), wherein the content code provides restricted content distribution based on the BD+ standard, utilizing traps within the program to partition the content code at the host processor based on functions to be performed by the content code, and forwarding commands and parameters associated with portions of the content code relating to computations involving confidential data to a secure processor for decrypting the encrypted multimedia content.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 depicts a top-level diagram of a system according to an embodiment of the present disclosure for executing content code in a secure environment.

FIG. 2 is a block diagram illustrating an exemplary embodiment of the playback system in FIG. 1 for securely executing content code.

FIG. 3 illustrates additional components of the playback system in FIG. 1 for securely executing content code.

FIG. 4 illustrates the flow of data in the playback system of FIG. 1.

FIG. 5 illustrates an embodiment of the playback system shown in FIG. 1 for executing the various components shown in FIGS. 2-3.

FIG. 6 is a flow diagram for a method being executed in the playback system of FIG. 1.

FIG. 7 is a flow diagram for performing status checks between the host processor and the secure processor.

FIG. 8 illustrates a high-level diagram of the AACS protection scheme.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

In response to unauthorized copying and distribution of multimedia content, publishers and authors of audio/visual works have relied on various technologies that control access to digital content. BD+ is a component of the Blu-ray Disc Digital Rights Management system which was developed by Cryptography Research Inc. (CRI). Specifically, BD+ is a virtual machine (VM) embedded in authorized players that allows content providers to include executable programs (e.g., a BD+ program) on Blu-ray Discs. Such programs examine the host environment to determine whether the player has been tampered with. Generally, every licensed playback device manufacturer provides the BD+ licensing authority with memory footprints that identify their devices. Such programs can also verify that the player's keys have not been changed. The programs can also limit playback of a Blu-Ray disc to the device in which the disc is played. If a disc manufacturer or content owner finds that its devices have been hacked, it can potentially release BD+ code that detects and circumvents the vulnerability. These programs can then be included in all new disc releases.

BD+ licensed BD-ROM players are issued BD+ signatures and a certificate that is signed by a BD+ licensing authority. The security check performed by the VM matches the player's BD+ security keys with the player's certificate. This check ensures that keys have not been compromised or stolen from another playback environment and inserted into the environment being checked. Once the keys and certificates have been checked, the VM examines the player's playback environment. Each player manufacturer provides the BD+ licensing authority with a memory footprint that can be used to identify their playback environment.

Even within the BD+ framework, however, obstacles remain in maintaining security for BD players implemented in software given that personal computers generally operate in an open environment. In some instances, software code can be extracted, dissected, and analyzed, thereby exposing sensitive data such as BD+ security keys embedded within the program. This can prove to be very costly as such data as decryption keys used for distributing content implementing the BD+ framework may be vulnerable to being hacked and reused. For example, it may be possible to examine blocks of memory holding keys to gain unauthorized access to protected content.

Various embodiments are disclosed for implementing a secure, closed environment for implementing digital rights management schemes by incorporating a hardware protection module that works in conjunction with a host processor where sensitive data such as cryptographic keys and multimedia content are processed the hardware protection module. Generally, the hardware protection module provides a secure platform for providing cryptographic services. Encrypted content and content code are received from a Blu-ray Disc or other storage medium and certain portions of the content code are executed within a hardware protection module, where such functions as cryptographic functions are performed. Furthermore, protected content comprising multimedia content (e.g., a movie title stored on a Blu-ray Disc) is decrypted and decoded in a secure environment. The “content code” referred to in this disclosure generally relates to native code and/or executables located on storage media that are executed upon disc insertion. In this respect, content providers can customize content code on such storage media as Blu-ray Discs to perform content protection functions. One of the most common functions involves examining the host environment receiving the Blu-ray Disc in order to determine whether the player application within the host environment has been tampered with.

In one implementation, the playback system includes a host processor running a virtual machine (VM), which executes a program stored on a BD. A secure processor within the hardware protection module is communicatively coupled to the host and configured to receive encrypted content, decrypt the encrypted content, and execute certain functions associated with the program received from the BD. The output generated by the hardware protection module may comprise video/audio content sent to a display. To ensure secure transmission of the decoded content, the output may be selectively sent only to devices that are compliant with such output protection management (OPM) standards as HDCP (High-bandwidth Digital Content Protection), which provides for secure transmission of sensitive data over such connections as Digital Visual Interface (DVI) or High-Definition Multimedia Interface (HDMI) connections.

For the embodiments disclosed, the secure hardware protection module provides security measures in order to provide a secure, closed environment. As will be described later, a secure processor within the secure hardware protection module may comprise a processing unit that executes a proprietary instruction set. That is, the instruction set is not one generally known and used by the public. It should be noted, however, that the secure processor described herein is not limited to processors that execute proprietary instruction sets. Furthermore, the secure processor may operate in conjunction with restricted access random access memory (RAM) that is configured to interface strictly with the secure processor within the hardware protection module.

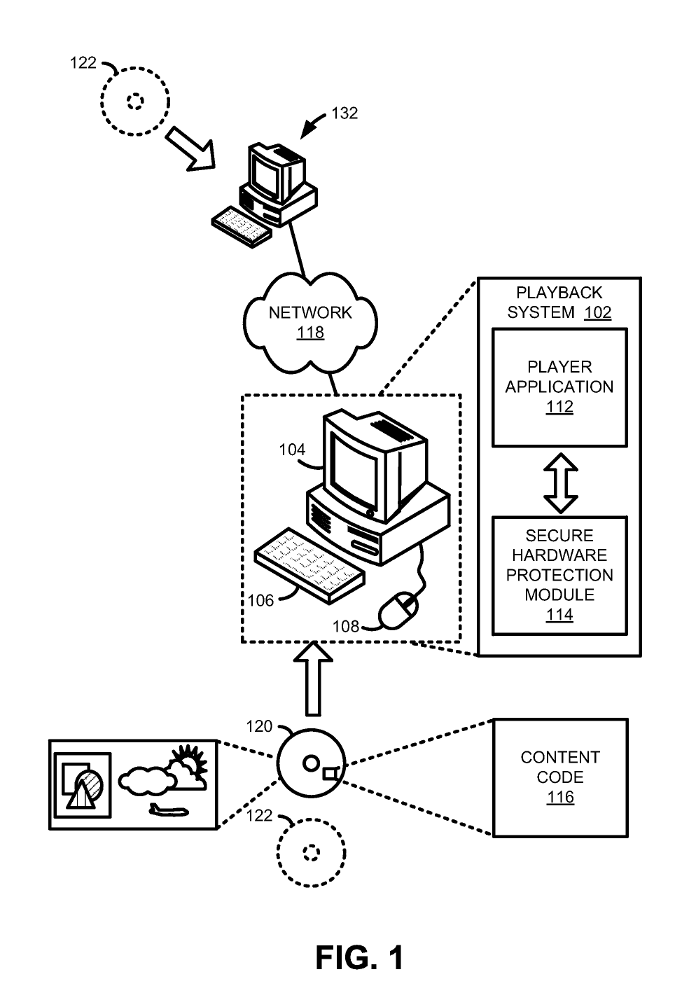

Reference is made to FIG. 1, which depicts a top-level diagram of a system according to an embodiment of the present disclosure for executing content code in a secure environment. The system includes content code 116 stored on a storage medium 120 such as a Blu-ray disc (BD) or other optical disc. The content code 116 generally refers to a program or executable for implementing security measures or policies in the playback system 102 to prevent unauthorized access to the multimedia content stored on the storage medium 120. For some embodiments, the content code 116 refers to BD+ copy protection code which is executed by a virtual machine embedded in playback system 102 such as the one depicted in FIG. 1.

The function of the content code 116 is to examine the playback system 102 and determine whether the player application 112 is authorized to access the multimedia content stored on the storage medium 120. Specifically, the content code 116 verifies that certain keys embedded in the player application 112 have not been changed or tampered with. Note that for some embodiments, some or all of these keys may be encrypted prior to distribution of the player application. In accordance with some embodiments, the content code 116 may also be embedded into authorized copies of a Blu-ray Disc 122. These authorized copies 122 are protected by AACS (Advanced Access Content System), which is a standard relating to content distribution and digital rights management. To protect against unauthorized distribution of media content, authorized copies 122 are protected by DRM (digital rights management) such that uncontrolled copying is prevented.

The content code 116 stored on a storage medium 120 or authorized copy 122 is received by the playback system 102, which may be embodied as, for example, a computer workstation, laptop, or other computing device. The playback system 102 receives the storage medium (e.g., BD disc) 120 storing the content code 116 via an optical disc drive or other means. The playback system 102 further includes a display 104 and input devices such as a keyboard 106 and a mouse 108. The playback system 102 may be configured to provide a user interface, which a user utilizes to select movie titles to view or to access interactive features stored on the storage medium 120.

As shown in FIG. 1, the playback system 102 comprises a player application 112 and a secure hardware protection module 114. The player application 112 decodes and renders the media content stored on the storage medium 120. Before the player application 112 can access the media content stored on the storage medium 120, however, the content code 116 examines the host environment and performs a check to determine if the player application 112 is authorized to access the protected media content. Specifically, the content code 116 interfaces with the secure hardware protection interface 114 to determine whether the keys associated with the player application 112 are valid or have been tampered with.

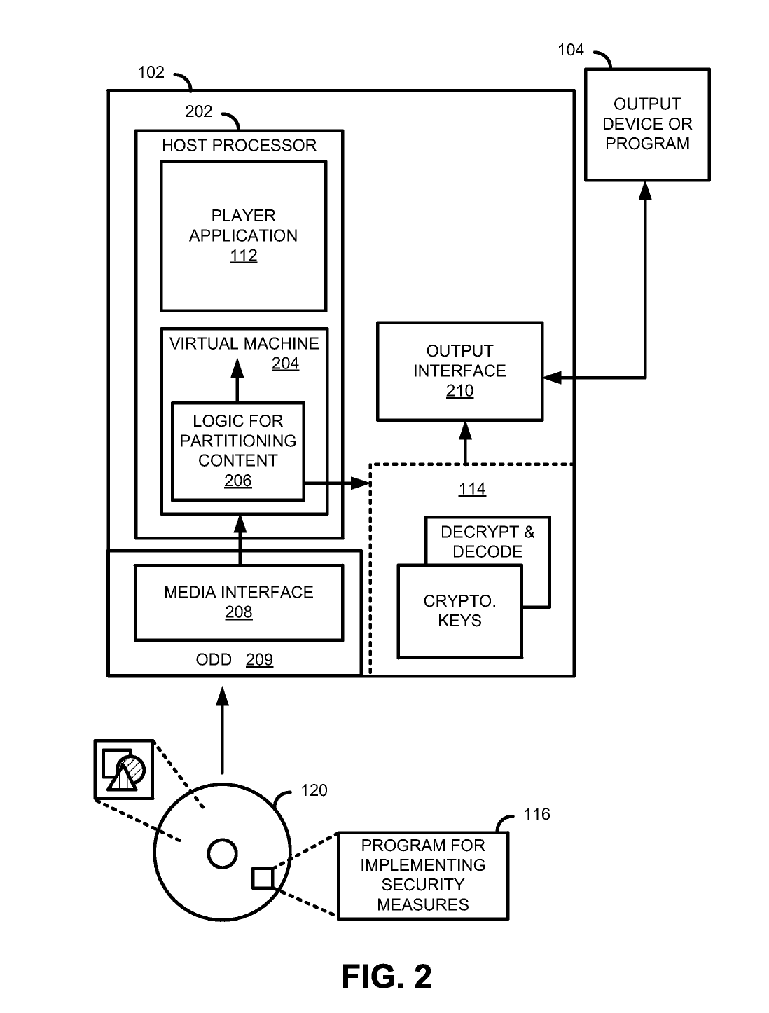

Reference is made to FIG. 2, which is a block diagram illustrating an embodiment of the playback system in FIG. 1 for securely executing content code. The playback system 102 may comprise a host processor 202, a media interface 208, a secure hardware protection module 114, and an output interface 210. The host processor 202 executes a player application 112 and includes a virtual machine 204 for executing content code 116 stored on a storage medium 120 such as a Blu-ray Disc. As described earlier, the content code 116 stored on the storage medium 120 may incorporate the BD+ framework for determining whether the player application 112 is an authorized player by examining various aspects of the host environment within the playback system 102. The media interface 208 is generally implemented within an optical disc drive 209 and receives content code 116 and encrypted multimedia content from the storage medium 120 and forwards the received content to partitioning logic 206.

The virtual machine 204 of the host processor 202 further includes the logic 206 for partitioning content code 116 read from the storage medium 120 and determines which portion of the content code 116 to execute locally in the host processor 202 and which portion to execute within the secure hardware protection module 114. The partitioning logic 206 sends a series of commands and data/parameters associated with portions of the content code 116 to the secure hardware protection module 114 directing the secure hardware protection module 114 to perform functions and computations relating to sensitive or confidential data. As described earlier, the encrypted content in this case may comprise commands, messages, and/or parameters associated with portions of content code that involve sensitive or confidential data. Such portions of content may comprise, for example, certain steps which are sensitive or critical to the restricted access framework.

These steps may be embodied as micro-instructions or sub-instructions as known by those of ordinary skill in the art. Further, these steps are used to perform certain calculations related to keys or other sensitive data. The virtual machine of the host processor includes logic for determining and partitioning which portion of the program to execute locally and which portion of the program to offload to the secure environment. For example, the portion of a playback application which generates keys for decrypting content on a BD may be executed on the secure processor. This may be accomplished by sending a series of commands, messages, and data/parameters to the secure processor instructing the secure processor to perform specific computations relating to sensitive data. The results from the computations are then sent back to the host processor, which resumes execution of the program. In this regard, the secure processor may be used to provide secure cryptographic services.

By way of illustration, reference is made to the non-limiting example below. The example comprises a call to a TRAP_AES operation. For purposes of this illustration, a simplified version of this operation is outlined below:

TRAP_AES

| | |
|---|---|
| Step 1: | if (opOrKeyID == AES_ECB_DECRYPT) then |
| Step 2: | perform AES-D use keyX as key on data in src and store |
| | result in dst |
| Step 3: | else if (opOrKeyID == 1) then |
| Step 4: | perform AES-D use “player's AES key#1” as key on |
| | keyX and store the result as keyY |
| Step 5: | perform AES-D use keyY as key on data in src and store |
| | result in dst |
| Step 6: | End |

As seen in the example above, a single instruction or operation may actually comprise one or more steps (or micro/sub-instructions). Sub-instructions that don't involve confidential or sensitive data (e.g., Steps 2 and 5) may be executed by the host processor 202. Step 4, however, involves confidential data (i.e., a player application's AES key) and is thus executed by the secure processor 520 in the secure hardware protection module 114. Rather than sending the sub-instruction directly to the secure processor 520, a command and parameters are sent. For Step 4, for example, the command/parameters may comprise (AESD, 1, keyX). The secure processor 520 executes the command based on the parameters and returns a calculation result keyY. For some implementations, an interpreter for generating the commands and parameters may be hard-coded in each place where a trap is implemented.

The commands/parameters may comprise, for example, BD+ keys, a decryption table, algorithm parameters such as those related to ECDSA (Elliptic Curve Digital Signature Algorithm) signature and verification algorithms. Note that for various implementations, the decryption table used for decryption may be pre-stored in the player application 112 or calculated during execution of the content code 116 by the virtual machine 204 of the host processor 202. Specifically, for some implementations, the table may be generated by BD+ content code. Depending on how the content code 116 is implemented, the decryption table is usually embedded within the content code 116 and then generated or decrypted by the content code 116. The decryption table is typically generated by the content provider of the multimedia content on the storage medium 120.

The function of the decryption table is generally defined by the DRM framework. For implementations incorporating the BD+ framework, the decryption table is referred to as a “fix-up table.” Even after AACS decryption is performed, there are still portions of data that remain corrupted or scrambled for security purposes. The BD+ framework utilizes the decryption table or “fix-up table” to process the scrambled portions of data. In this regard, the “fix-up table” contains information on what data is scrambled and what data to process or correct. Further, this correction process is performed in the secure hardware protection module 114. Note that some portions of the fix-up table may be masked. A calculation is performed by the content code 116 to unmask the fix-up table. For some embodiments, the unmasking process may involve performing an arithmetic operation between the calculation and confidential/sensitive data. As the unmasking process involves confidential/sensitive data, the process may also be performed within the secure hardware protection module 114.

For some embodiments, the secure hardware protection module 114 may be further configured to decrypt the encrypted multimedia content stored on the storage medium 120 once the player application 112 is determined to be an authorized player. For such embodiments, portions of the player application 112 may be executed in the secure hardware protection module 114. Once the multimedia content is decrypted, the multimedia content may either be decoded within the secure hardware protection module 114 or decoded by the host processor 202. For such embodiments, the host processor 202 may decode the multimedia content based on data (e.g., keys) generated by the secure hardware protection module 114. Upon rendering the multimedia content, the secure hardware protection module 114 forwards the content to an output interface 210, which may then forward the content to an output device or another application/program 104.

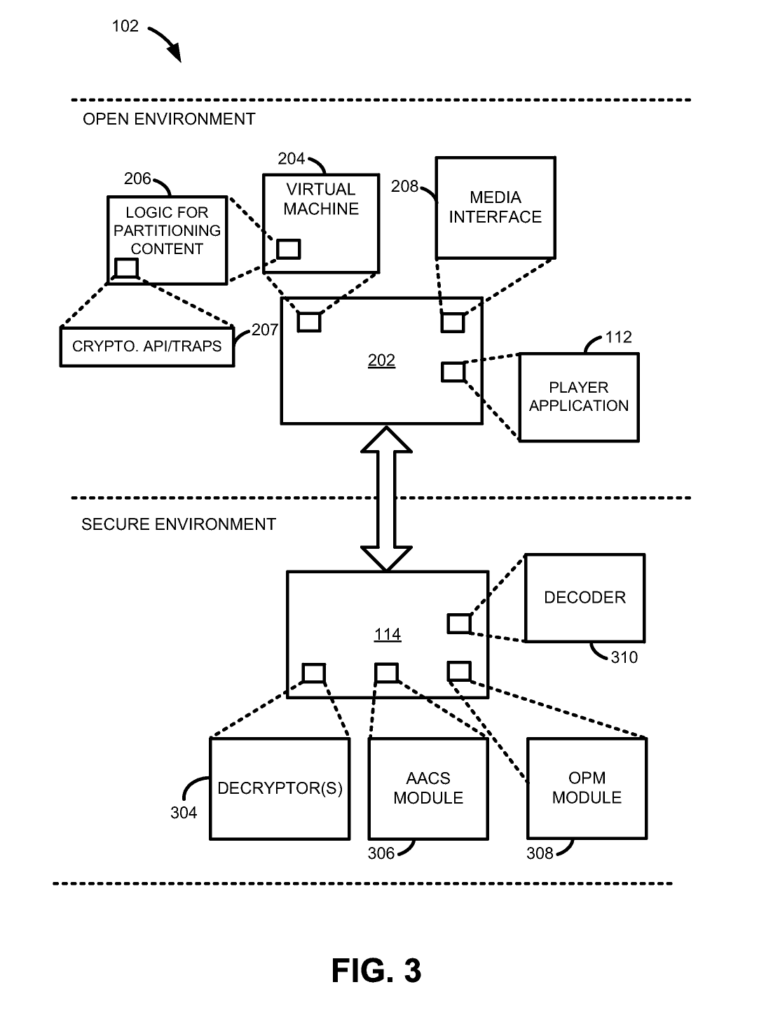

FIG. 3 illustrates additional components of the playback system 102 in FIG. 1 for securely executing content code. As illustrated by the demarcation line in FIG. 3, the playback system 102 includes both an open environment and a closed/secure environment. While in some embodiments, all the components depicted in FIG. 3 may be executed in a secure hardware environment, other embodiments are described whereby certain components or modules are executed in the open environment in order balance the cost associated with customized hardware and resources needed to playback multimedia content entirely in a secure environment. It should be noted that while various portions of content code 116 are executed by the host processor 202 in an open environment, however, a secure means for executing content code 116 may still be achieved by executing only portions of content code 116 involving confidential or sensitive data (such as cryptographic keys, for example) in the secure hardware protection module 114.

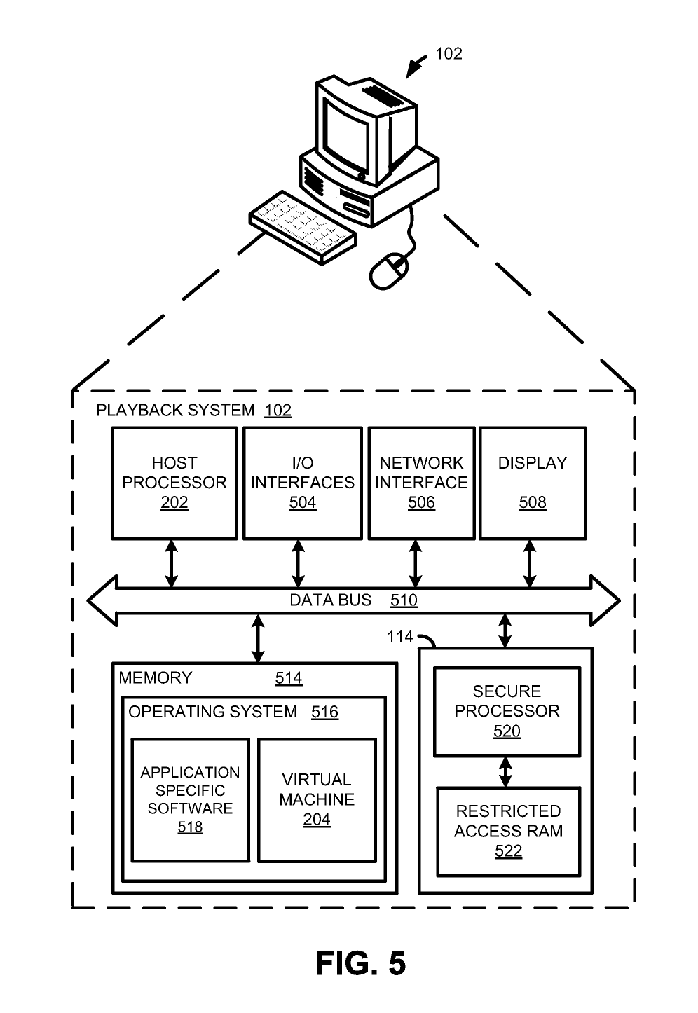

As depicted in FIG. 3, various modules or components are executed by the host processor 202 shown in FIG. 2. These modules include a media interface 208, a virtual machine 204, and a player application 112. The virtual machine 204 further comprises logic for partitioning content 206. For some implementations, the partitioning logic 206 may be embodied, for example, as APIs (application programming interfaces) or traps 207 embedded within the player application 112 or virtual machine 204. Within the secure environment, the playback system 102 further comprises a secure hardware protection module 114. Referring briefly to FIG. 5, the secure hardware protection module 114 comprises a secure processor 520 and a restricted access RAM 522. It should be noted that one of ordinary skill in the art will appreciate that the secure hardware protection module 114 may, and typically will, comprise other components, which have been omitted as these additional components are not necessary to one of ordinary skill to reach an understanding of how to implement the various embodiments described. The secure processor 520 is configured to perform cryptographic functions based on commands and parameters received from the host processor 202.

For preferred embodiments, the secure processor 520 receives commands, message, and/or parameters associated with certain functions that are first encrypted by the host processor 202 before being sent to the secure processor 520. The secure processor 520 includes a decryptor 304 for decrypting the commands/data associated with portions of the content code using one or more keys shared between the secure processor 520 and the host processor 202 and executes the specified computations. The results from the computations may be temporarily stored in the restricted access RAM 522 before being sent back to the host processor 202. For various embodiments, the secure processor 520 and the restricted access RAM 522 may be configured such that the secure processor 520 encrypts data prior to storing the data in the restricted access RAM 522. Thus, even if the data is read from the restricted access RAM 522 by another device, the data is encrypted. Depending on the size of the restricted access RAM 522, the secure processor 520 and the restricted access RAM 522 may be physically integrated onto a single chip or circuit, such as an ASIC, thereby providing an actual closed environment for secure execution of functions involving sensitive data.

Referring back to FIG. 3, the secure hardware protection module 114 comprises one or more decryptors 304, an AACS module 306, and a decoder 310 for rendering multimedia content stored on the storage medium 120. For embodiments in which some or all of these components 304, 306, 310 are embodied in software stored on a tangible medium, the components 304, 306, 310 are executed by the secure processor 220 depicted in FIG. 5. In some implementations, the secure hardware protection module 114 may also include an OPM (output protection management) module 308. For such embodiments, the decoder 310 outputs the decoded video content to devices that have incorporated a restricted access scheme such as High-bandwidth Digital Content Protection (HDCP), Analog Content Protection (ACP), or Copy Generation Management System (CGMS) as known by those skilled in the art. Such protection mechanisms may be incorporated in the OPM module 308.

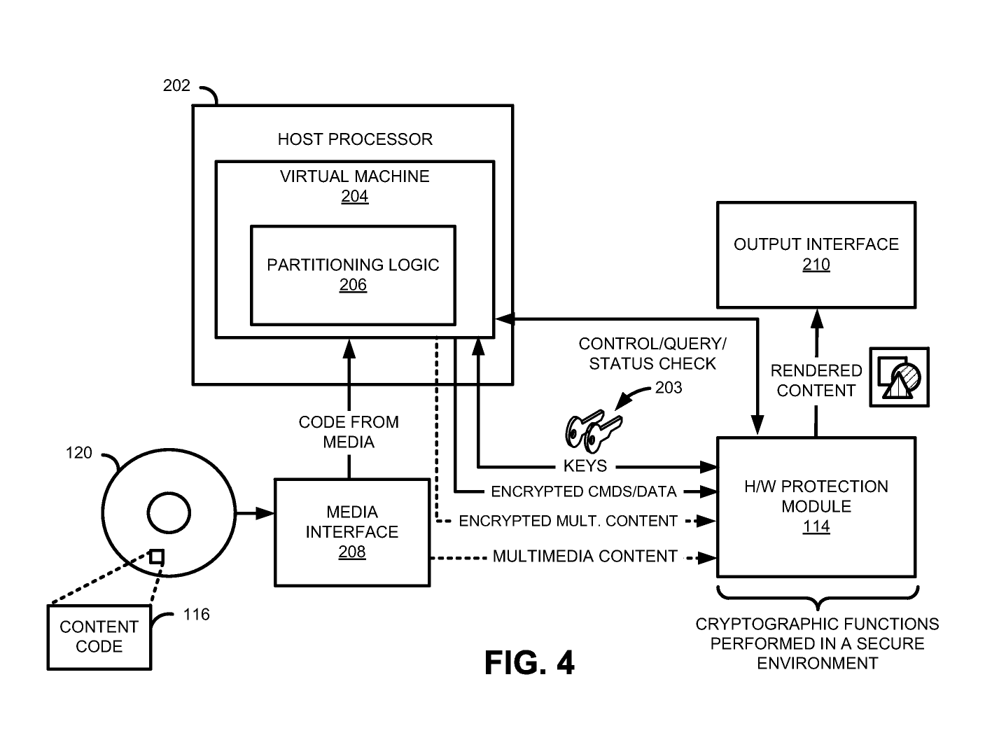

Reference is made to FIG. 4, which illustrates the flow of data within the playback system 102 of FIG. 1. Content code 116 and multimedia content stored on a storage medium 120 are received by a media interface 208. The content code 116 is forwarded to partitioning logic 206 within the virtual machine 204 of the host processor 202 where portions of the content code 116 not involving sensitive or confidential data (e.g., keys) are executed locally by the virtual machine 204 in the host processor 202. Functions in the content code 116 that involve sensitive or confidential data (e.g., keys) are forwarded to the secure hardware protection module 114 in the form of commands and parameters which are first encrypted using keys 203 shared between the host processor 202 and the secure hardware protection module 114 prior to being forwarded to the secure hardware protection module 114. In this regard, the data forwarded to the secure hardware protection module 114 is encapsulated with an internal layer of encryption implemented between the host processor 202 and the secure processor 520 within the secure hardware protection module 114.

Using the keys 203 to encrypt a series of commands and data, the host processor 202 offloads the data-sensitive portions of the content code 116 to the secure hardware protection module 114 for execution. For implementations where the multimedia content stored on the storage medium 120 is decrypted within the secure hardware protection module 114. For other implementations, however, the media interface 208 forwards the multimedia content received from the storage medium 120 directly to the secure hardware protection module 114.

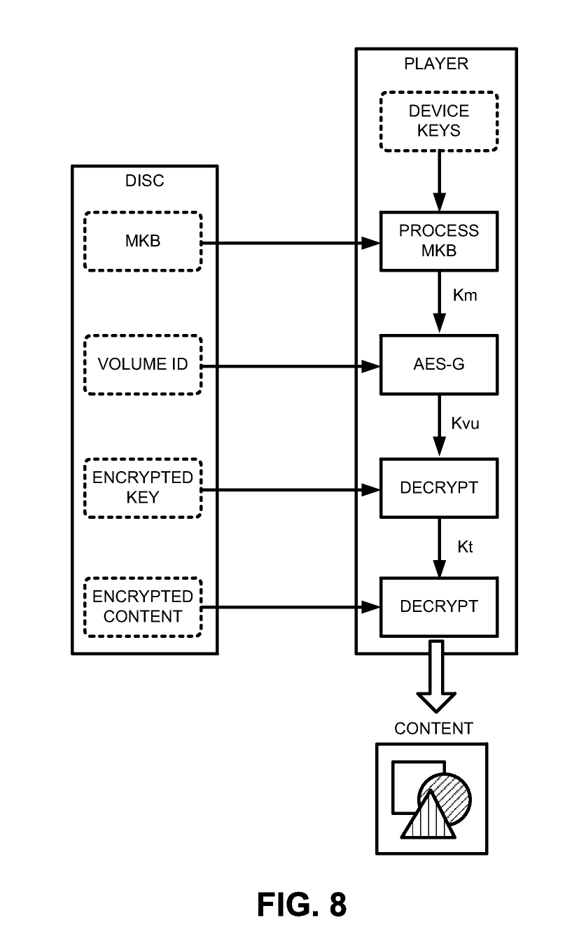

For some implementations, the secure hardware protection module 114 may contain different decryptors 304 for different functions. One decryptor, for example, may be configured to decrypt encrypted command/parameters associated with the portions of the content code 116 sent from the host processor 202. Another decryptor may be configured to decrypt the multimedia content on the storage medium 120 based on commands/parameters decrypted by the first decryptor. At the secure hardware protection module 114, the decryptor 304 shown in FIG. 3 decrypts the portion of the content code received from the host processor 202 using the keys 203. As known by those skilled in the art, the BD+ standard provides an additional layer of protection on top of the AACS (Advanced Access Content System) protection scheme. The multimedia content on a storage medium 120 may be categorized into two categories—the main multimedia content itself and volume info relating to the disc. With reference to FIG. 8, under the AACS standard, this volume info is referred to as the Media Key Block (MKB). The MKB allows compliant players (e.g., software players that have incorporated a license under the AACS licensing administrator) to calculate a “secret” key using device keys embedded into the players.

The AACS scheme encrypts content under one or more title keys using AES. These title keys are derived from a combination of the media key and other pieces of information, including the volume ID associated with the disc. In this regard, even if an unauthorized user tampers with the system and manages to retrieve one of the title keys, this only allows the user to decrypt a portion of the content. To perform secure playback of multimedia content, the playback apparatus 102 includes a player application 110 and a hardware protection module 112 to protect against unauthorized access of the AACS keys described above.

By protecting the AACS keys and processing the AACS keys in a closed, secure environment, the AACS keys are protected against tampering. The AACS module 306 receives content protected under the AACS scheme and implements restricted access for content distribution. Specifically, the AACS module 306 decrypts the multimedia content stored on the storage medium 120 using the MKB, the Volume ID, and the encrypted title keys. Once the MKB is decrypted, the Media Key is combined with the Volume ID to produce the Volume Unique key. The Volume Unique Key is used to decrypt the encrypted title keys, which are then used to decrypt the encrypted multimedia content. To complete the steps described above, the AACS module 306 may utilized the restricted access RAM 522. While the actual decryption process under the AACS standard falls outside the scope of this disclosure, it should be emphasized that the AACS module 306 which performs the calculation of keys is executed in a closed environment by the secure processor 520 within the secure hardware protection module 114.

The decryption and decoding of the multimedia content itself may be performed either by the secure processor 520 or the host processor 202, depending on the implementation. To minimize the level of complexity, the secure processor 520 may off-load the decryption and decoding of the content to the host processor 202, which may have more computing resources available. Referring back to FIG. 4, the host processor 202 periodically queries the secure hardware protection module 114 to perform a series of control checks or status checks in order to monitor the execution of content code 116 by the secure processor 520.

FIG. 5 illustrates an embodiment of the playback system shown in FIG. 1 for executing the various components shown in FIGS. 2-3. The playback system 102 may comprise any one of a wide variety of wired and/or wireless computing devices, such as a desktop computer, portable computer, dedicated server computer, multiprocessor computing device, and so forth. Irrespective of the specific arrangement, the playback system 102 may comprise memory 514, a host processor 202, a number of input/output interfaces 504, a network interface 506, a display 508, and mass storage (not shown), wherein each of these devices are connected across a data bus 510.

The host processor 202 may be comprised of any custom made or commercially available processor, a central processing unit (CPU), or an auxiliary processor among several processors associated with the playback system 102. The memory 514 can include any one or a combination of volatile memory elements (e.g., random-access memory (RAM, such as DRAM, and SRAM, etc.)) and nonvolatile memory elements (e.g., ROM, hard drive, CDROM, etc.). The memory 514 typically comprises a native operating system 516, one or more native applications, emulation systems, or emulated applications for any of a variety of operating systems and/or emulated hardware platforms, emulated operating systems, etc. For example, the applications may include application specific software 518 stored on a computer-readable medium for execution by the host processor 202 and may include the virtual machine 204 described with respect to FIG. 2. One of ordinary skill in the art will appreciate that the memory 514 can, and typically will, comprise other components which have been omitted for purposes of brevity.

The secure processor 520 shown in FIG. 5 may either be integrated into the playback system 102 or may be a stand alone apparatus. As a non-limiting example, in some implementations, the host processor 202 and the secure processor 520 may be both located on the same motherboard of the playback system 102. In other embodiments, however, the secure processor 520 may be located on a separate board such as a graphics card, which may then plug into a slot within the playback system 102. The secure processor 520 communicates with the host processor 202 over the data bus 510.

To ensure security, the secure processor 520 and the host processor 502 may incorporate a security measure such as use of an encryption protocol when sending data back and forth. For some implementations, the secure processor 520 may also be configured such that only the host processor 502 can access the secure processor 520. As described earlier, the secure processor 520 may be configured to execute a proprietary instruction set not generally known and used by the public. Furthermore, the secure processor 520 may operate in conjunction with restricted access random access memory (RAM) 522 configured to interface strictly with the secure processor 520.

For exemplary embodiments, the internal details and specifications of the secure processor 520 are proprietary in nature. For example, the secure processor 520 may utilize a proprietary instruction set, a customized memory layout, a proprietary data encoding scheme, a unique circuit design, and so on. These characteristics of the secure processor 520 make it more difficult to access and tamper with the secure processor 520, relative to the open environment of the playback system 102. For some embodiments, the components of the secure processor 520 are integrated into a single ASIC (application specific integrated circuit). Furthermore, the secure processor 520 may be embodied as an individual component that is separate from the host processor 202 of the playback system 102.

Input/output interfaces 504 provide any number of interfaces for the input and output of data. For example, where the playback system 102 comprises a personal computer, these components may interface with a user input device 504, which may be a keyboard or a mouse, as shown in FIG. 1. Display 508 receives content from the output interface 210 shown in the FIG. 4 and can comprise, for example, a computer monitor. Where any of the components described above comprises software, it should be understood that the software is embodied as code stored on a computer-readable medium for execution by a processor in a computer system or other system. In the context of the present disclosure, a computer-readable medium refers to any tangible medium that can contain, store, or maintain the software or code for use by or in connection with an instruction execution system.

For example, a computer-readable medium may comprise an optical disc and may store one or more programs such as the content code 116 described earlier for execution by the host processor 202. As other non-limiting examples, the computer-readable medium can be a portable computer diskette, a random access memory (RAM), a read-only memory (ROM), an erasable programmable read-only memory (EPROM, EEPROM, or Flash memory), or a portable compact disc read-only memory (CD-ROM). With further reference to FIG. 5, the network interface device 506 comprises various components used to transmit and/or receive data over a network environment. By way of example, the network interface 506 may include a device that can communicate with both inputs and outputs, for instance, a modulator/demodulator (e.g., a modem), wireless (e.g., radio frequency (RF)) transceiver, a telephonic interface, a bridge, a router, network card, etc.).

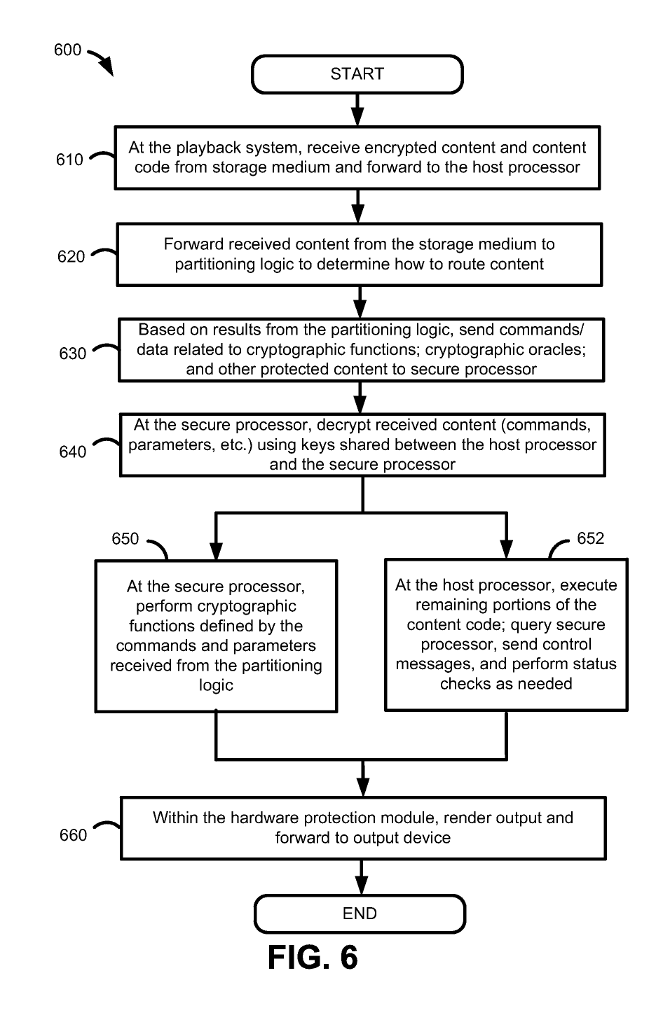

Reference is now made to FIG. 6, which illustrates an embodiment of the playback system shown in FIG. 1 for executing the various components shown in FIGS. 2-3. Beginning with block 610, encrypted multimedia content and content code are received from a storage medium (e.g., a Blu-ray Disc) and forwarded to the host processor at the playback system. In block 620, the received content comprising the content code (e.g., BD+ code) and the multimedia content (e.g., movie title) are forwarded from the storage medium 120 to partitioning logic 206 within the playback system 102 to determine where to perform functions defined within the content code 116. As described earlier, the partitioning logic 206 may be implemented in the form of APIs or traps that monitor execution of the content code 116 for any functions relating to sensitive data.

For some embodiments, the execution of the content code 116 may be halted and computation of confidential or sensitive data may be offloaded to the secure processor 520. The results from the computations are received by the host processor 202 and execution of the content code 116 resumes. In block 630, based on results from the partitioning logic 206, the functions within the content code 116 related to such functions as cryptographic functions, cryptographic oracles, and other protected content are forwarded in the form of commands and parameters to the secure processor 520 for execution within secure hardware protection module 114. At the secure processor 520, the received content (commands, parameters, etc.) is decrypted using one or more keys 203 shared between the host processor 202 and the secure processor 520 (block 640).

In block 650, the secure processor 520 executes the decrypted commands forwarded from the host processor 202. The commands may be related to various cryptographic functions for decrypting the encrypted multimedia content from the BD disc whereby the playback system 102 is examined to verify that keys associated with the player application 112 have not been tampered with. At the host processor 202, any remaining portions of content code 116 are executed (block 652). Furthermore, the host processor 202 periodically queries the secure processor 520 and sends control messages to monitor the progress of commands being executed within the secure hardware protection module 114. Within the secure hardware protection module 114, the multimedia content is decrypted, decoded, and forwarded to an output device 104 (block 660).

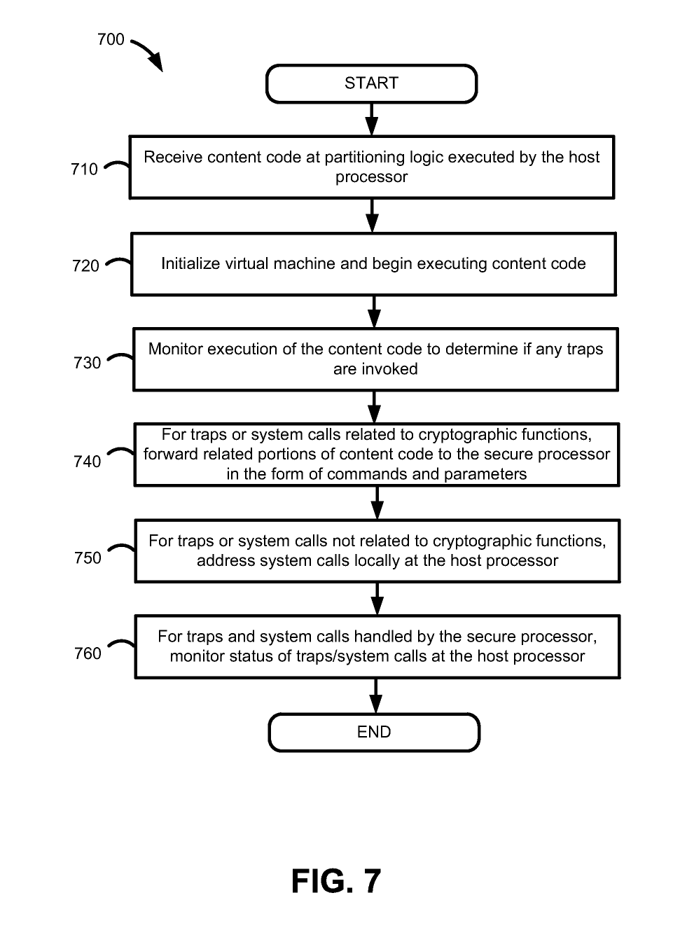

FIG. 7 is a flow diagram for performing status checks between the host processor and the secure processor. Block 710 begins by receiving content code 116 at partitioning logic 206 executed by the host processor 202. Block 720 proceeds by initializing the virtual machine 204 and executing the content code 116. In block 730, the execution of the content code 116 is monitored to determine if any traps are invoked. For traps or system calls related to cryptographic functions or other computation involving confidential data, the related portions of content code 116 are forwarded to the secure hardware protection module 114 in the form of commands and parameters, and specifically, to the secure processor 520 and restricted access RAM 522 for secure execution within a closed environment (block 740). In block 750, traps or system calls not related to cryptographic functions are addressed locally at the host processor 202. In block 760, for traps and system calls handled by the secure processor 520, the host processor 202 monitors the status of traps and system calls handled by the secure processor 520.

The methods or processes described above are not limited to the particular sequence of steps described. As one of ordinary skill in the art will appreciate, other sequences of steps may be possible, and the particular order of steps set forth herein should not be construed as limitations on the claims. One skilled in the art can readily appreciate that the sequences may be varied and still remain within the spirit and scope of the present invention. Finally, it should also be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

At least the following is claimed:

1. A method for executing digital rights management software comprising content code and outputting multimedia content within a secure environment, comprising:
receiving encrypted multimedia content and content code from a storage medium by a host processor, wherein the content code provides restricted content distribution by examining an environment in which a player application resides;
based on functions defined within the content code, partitioning the content code into portions by a host processor; and
based on whether the functions corresponding to the portions are related to computations involving confidential data, generating and forwarding commands and parameters related to the portions of the content code to a secure processor for decrypting the encrypted multimedia content.

2. The method of claim 1, wherein the content code is executed by a virtual machine on the host processor.

3. The method of claim 1, wherein the confidential data comprises:
encrypted keys; and
a decryption table.

4. The method of claim 3, wherein the encrypted keys are embedded within the player application.

5. The method of claim 3, wherein the decryption table is embedded within the player application and read by the host processor.

6. The method of claim 3, wherein the decryption table is calculated during execution of the content code by a virtual machine of the host processor.

7. The method of claim 1, wherein generating and forwarding commands and parameters to a secure processor comprises first encrypting the commands and parameters associated with portions of the content code using keys shared between the host processor and the secure processor.

8. The method of claim 1, further comprising:
at the secure processor, executing authentication commands in conjunction with the host processor to determine whether the player application is an authorized player, wherein the authentication commands are executed based on the content code;
decrypting received commands and parameters related to the portions of content code at the secure processor;
executing the commands based on the parameters at the secure processor to decrypt the encrypted multimedia content; and
transmitting the multimedia content to an output device.

9. The method of claim 1, wherein functions corresponding to the portions related to computations involving confidential data comprise sub-instructions and micro-instructions.

10. The method of claim 8, further comprising decoding the multimedia content by the secure processor after decrypting received commands and parameters related to the portions of content code at the secure processor.

11. The method of claim 8, further comprising decoding the multimedia content by the host processor after decrypting received commands and parameters related to the portions of content code at the secure processor.

12. The method of claim 8, further comprising executing any remaining portions of the content code not executed by the secure processor at the host processor.

13. The method of claim 8, further comprising the host processor querying the secure processor to monitor execution of the commands being executed by the secure processor.

14. The method of claim 8, wherein transmitting the multimedia content to an output device comprises outputting the multimedia content to an output device that has incorporated a restricted access standard comprising one of:
High-bandwidth Digital Content Protection (HDCP),
Analog Content Protection (ACP), and
Copy Generation Management System (CGMS).

15. A playback system for executing digital rights management software and outputting multimedia content, comprising:
a media interface for receiving the encrypted multimedia content and content code from a storage medium;
a host processor configured to execute logic for partitioning the content code into portions based on functions to be performed by the content code;
a secure hardware protection module communicatively coupled to the host processor, wherein the secure hardware protection module comprises a secure processor configured to receive and execute commands associated with the portions of the content code related to computations involving confidential data, wherein the secure processor is accessible only by the host processor; and
an output interface configured to output decoded multimedia content to an output device.

16. The system of claim 15, wherein the secure hardware protection module comprises random access memory (RAM) accessible only by the secure processor.

17. The system of claim 15, wherein the host processor is further configured to implement a virtual machine for executing and partitioning the content code.

18. The system of claim 11, wherein the partitioning logic is configured to implement traps within the content code to monitor for computations involving confidential data within the content code.

19. The system of claim 15, wherein the host processor is configured to encrypt the commands prior to sending the commands to the hardware protection module based on keys shared between the host processor and the secure processor.

20. The system of claim 19, wherein the secure hardware protection module further comprises a decryptor for decrypting encrypted commands received form the host processor.

21. The system of claim 15, wherein the content code comprises BD+ virtual machine-based code.

22. The system of claim 15, wherein the storage medium is a BD disc.

23. The system of claim 15, wherein the hardware protection module further comprises an OPM (output protection management) module configured to support a restricted access standard comprising one of:
High-bandwidth Digital Content Protection (HDCP),
Analog Content Protection (ACP), and
Copy Generation Management System (CGMS).

24. A computer-readable medium storing a program for execution on a host processor, the program comprising computer executable instructions configured to perform the steps of:
receiving encrypted multimedia content and content code from a Blu-ray Disc (BD), wherein the content code provides restricted content distribution based on the BD+ standard;
utilizing traps within the program to partition the content code at the host processor based on functions to be performed by the content code; and
forwarding commands and parameters associated with portions of the content code relating to computations involving confidential data to a secure processor for decrypting the encrypted multimedia content.

25. The computer-readable medium of claim 15, further comprising a virtual machine for executing the BD+ content code.

26. The computer-readable medium of claim 15, wherein the program is further configured to perform playback of multimedia content stored on the BD.

27. The computer-readable medium of claim 26, wherein the program is further configured to receive data generated by execution of the commands by the secure processor, wherein the program utilizes the data to perform playback of the multimedia content.
